(19) United States
(12) Patent Application Publication
(10) Pub. No.: US 2025/0326428 A1
(43) Pub. Date: Oct. 23, 2025

(54) ELECTRONIC STEERING SYSTEMS AND APPARATUS FOR VEHICLES AND METHODS THEREOF

(71) Applicant: Ford Global Technologies, Dearborn, MI (US)

(72) Inventors: Alexander Ein Waldt, Köln (DE); Sergio Codonesu, Aachen (DE); Oliver Nehls, Düsseldorf (DE); Goetz-Philipp Wegner, Dortmund (DE)

(21) Appl. No.: 19/092,267

(22) Filed: Mar. 27, 2025

(30) Foreign Application Priority Data
Apr. 17, 2024 (DE) 102024110823.1

(51) Int. Cl. B62D 5/04; B62D 5/00

(52) U.S. Cl. CPC B62D 5/0484; B62D 5/001; B62D 5/0478

(57) ABSTRACT

Disclosed examples include setting a coupling resistance between a road wheel actuator and a steerable road wheel of a vehicle at a first time by controlling an electrical damping device to increase an electrical resistance of an electric motor of the road wheel actuator; and changing the coupling resistance between the road wheel actuator and the steerable road wheel at a second time by controlling the electrical damping device to further increase the electrical resistance of the electric motor of the road wheel actuator.

### RELATED APPLICATION

This patent claims priority from DE Patent Application Number 102024110823.1, which was filed on Apr. 17, 2024, and is hereby incorporated herein by reference in its entirety.

### FIELD OF THE DISCLOSURE

The disclosure generally relates to a method for operating a vehicle with an electronic steering system and to an electronic steering system for a vehicle.

### BACKGROUND

Electronic steering systems are an emerging steering technology that eliminates the mechanical link between the steering wheel and the road wheel and replaces it with two actuators: a steering wheel actuator with feedback, which generates a feedback torque for the driver (on the steering wheel) and a road wheel actuator that controls the road wheels to the desired position.

### SUMMARY

An example method includes setting a coupling resistance between a road wheel actuator and a steerable road wheel of a vehicle at a first time by controlling an electrical damping device to increase an electrical resistance of an electric motor of the road wheel actuator, and changing the coupling resistance between the road wheel actuator and the steerable road wheel at a second time by controlling the electrical damping device to further increase the electrical resistance of the electric motor of the road wheel actuator.

An example electronic steering system of a vehicle includes a road wheel actuator including an electric motor, an electrical short-circuit device coupled to the electric motor, the electrical short-circuit device to short circuit windings of the electric motor to generate a first electrical resistance of the electric motor that changes a coupling resistance between the road wheel actuator and a steerable road wheel, and an electrical damping device coupled to the electric motor, the electrical damping device controllable to generate a plurality of second electrical resistances, the second electrical resistances different from the first electrical resistance, the second electrical resistances to vary the coupling resistance between the road wheel actuator and the steerable road wheel.

An example steering system of a vehicle includes a road wheel actuator including an electric motor, an electrical damping device coupled to the electric motor, the electrical damping device controllable to generate a plurality of electrical resistances in the electric motor, the electrical resistances to vary a coupling resistance between the road wheel actuator and a steerable road wheel, and a mechanical damping device in a coupling path between the road wheel actuator and the steerable road wheel, the mechanical damping device configurable to vary the coupling resistance between the road wheel actuator and the steerable road wheel.

### BRIEF DESCRIPTION OF THE DRAWINGS

FIG. 1 shows a vehicle having an example electronic steering system in accordance with examples disclosed herein.

FIG. 2 shows another example of the vehicle with another electronic steering system and an auxiliary steering system in accordance with examples disclosed herein.

FIG. 3 is a flowchart representative of example machine-readable instructions and/or example operations that may be executed, instantiated, and/or performed by example programmable circuitry to implement electronic steering systems of vehicles in accordance with examples disclosed herein.

FIGS. 4 to 7 show schematic representations of an example electrical damping device in connection with electronic steering systems disclosed herein.

FIG. 8 shows a schematic representation of an auxiliary sensor in connection with auxiliary steering systems disclosed herein.

FIG. 9 shows a schematic illustration of a vehicle with another example electronic steering system in accordance with examples disclosed herein.

FIG. 10 is a block diagram of an example processing platform including programmable circuitry structured to execute, instantiate, and/or perform the example machine-readable instructions and/or perform the example operations of FIG. 3 to implement electronic steering systems and/or components thereof disclosed herein.

In general, the same reference numbers will be used throughout the drawing(s) and accompanying written description to refer to the same or like parts. The figures are not necessarily to scale.

### DETAILED DESCRIPTION

A fault in an electronic steering system of a vehicle can affect steering capability. As such, examples disclosed herein provide a steering system designed with sufficient redundancy to ensure that the vehicle can be transferred into a desired state, for example, to allow driving at a very low speed (“crawling speed”).

An electronic steering system that only provides one redundancy level can quickly (within a few minutes or even sooner) force the vehicle into a crawling state after a first fault, reducing the functionality of the vehicle. In addition, this transition represents a significant system change for the driver. For example, this can result in a generally uncomfortable, automatic reduction of the speed of the vehicle or even bring it to a stop. Examples disclosed herein provide additional redundancies to enable continued vehicle operation.

One way to add lateral control redundancy to the vehicle is to use other vehicle actuators, such as electric motors, that are assigned to each of the wheels of the vehicle. Different torques output by the electric motors can also be used to provide lateral control for the vehicle (known as tertiary lateral control or TLC), hereinafter referred to as auxiliary steering.

When the electronic steering system takes over the lateral control of the vehicle (e.g., in the normal operating state) with regard to the operation of the road wheel actuator, the steering system operates to maintain a low friction between the road wheel actuator(s) and the steerable road wheels. This allows for a more accurate estimation of the steering rack force, which is advantageous because the steering rack force has a large effect on the underlying control loop of the electronic steering system. For example, the steering rack force is an important signal used to provide the driver with torque feedback via the steering wheel actuator.

In contrast, for the TLC, a high resistance to the movement of the steerable road wheel is advantageous to achieve sufficient lateral control for certain driving maneuvers, such as constant cornering. For other driving maneuvers, however, a low resistance is advantageous so that the actuators of the TLC can generate the movement of the steerable road wheels with the desired dynamics.

From the prior art, electronic steering systems are known, which provide varying mechanical or electrical resistances with respect to the steering wheel actuator of an electronic steering system (EP 1 375 299 A1, WO 2004/069628 A2, JP 2004330840 A and JP 4475049 B2), for example, to implement the torque feedback to the driver more realistically in the event of a fault in the electronic steering system. In addition, systems are known which provide for a limitation of the effects of faults based on multiple electric motors (see US 2021/0269087 A1) or which provide triggering of fault operating states of the steering system with reduced maximum speeds (U.S. Pat. No. 11,780,493 B2).

Examples disclosed herein overcome the disadvantages of prior methods for operating a vehicle with an electronic steering system and of electronic steering systems. For example, examples disclosed herein increase the precision of the lateral control of the vehicle depending on the particular mechanism used for the vehicle lateral control and the driving situation (e.g., steering input), compared to previous approaches.

Some disclosed examples relate to methods of operating a vehicle with an electronic steering system. The electronic steering system has a road wheel actuator with an electric motor and an actuator control device (e.g., a road wheel actuator electronic control unit (ECU)) assigned to the road wheel actuator. The road wheel actuator is configured to cause a steering movement of at least one steerable road wheel. Some disclosed methods include at least the following:
varying a coupling resistance between the road wheel actuator and the steerable road wheel coupled to the road wheel actuator by a control device (e.g., an ECU) of the vehicle, using at least one of:
an electrical damping device,
an electrical short-circuit device and
a mechanical damping device.

The electrical damping device and/or the electrical short-circuit device are coupled to the electric motor of the road wheel actuator. The mechanical damping device is arranged in a coupling path between the road wheel actuator and the steerable road wheel coupled to the road wheel actuator or so as to act upon the road wheel actuator.

This creates a method that allows the coupling resistance between the road wheel actuator and the steering wheel coupled to it to be varied. More specifically, this allows the resistance to be adjusted and matched to the configuration of the electronic steering system, the steering specification and the driving situation, for example, in the case that a TLC is used for vehicle lateral control. This enables more precise control of the coupling between the road wheel actuator and the steerable road wheel. As a result, the precision for different driving situations and steering inputs can be increased compared to previous approaches because previous approaches only allow high precision for a single vehicle configuration. Examples disclosed herein may employ a TLC to provide dynamic control of the steerable road wheels.

In some disclosed examples of an electronic steering system for a vehicle, the electronic steering system comprises a road wheel actuator with an electric motor and an actuator control device assigned to the road wheel actuator. The road wheel actuator is configured to cause a steering movement of at least one steerable road wheel. The electronic steering system comprises at least one of:
an electrical damping device,
an electrical short-circuit device, and
a mechanical damping device.

The electrical damping device and/or the electrical short-circuit device are coupled to the electric motor of the road wheel actuator. The mechanical damping device is arranged in a coupling path between the road wheel actuator and the steerable road wheel coupled to the road wheel actuator or so as to act upon the road wheel actuator. A coupling resistance between the road wheel actuator and the steerable road wheel coupled to the road wheel actuator can be varied by a control device of the vehicle using the at least one of the electrical damping device, the electrical short-circuit device and the mechanical damping device.

Advantages achieved by example methods disclosed herein are also achieved by the electronic steering system in a corresponding manner.

The electronic steering system can in particular be understood to be a steer-by-wire (SbW) steering system.

As used herein, the electronic steering system of a vehicle refers to the conventional electronic steering system of the vehicle. In addition, however, examples disclosed herein may also be used to provide vehicle lateral control based on an auxiliary steering system, such as a TLC, as will be explained later.

As used herein, a coupling resistance refers to the total resistance (or total damping) of the coupling between the road wheel actuator and the steerable road wheel. Therefore, the coupling resistance includes a damping of or resistance to the movement of the steerable road wheels, which represents a component that is variable in the present case. In general, the coupling resistance also includes other system-inherent resistances, such as frictional resistances or the like. The coupling path between the road wheel actuator and the steerable road wheel may also include additional components, such as articulation devices or similar. Nevertheless, example devices disclosed herein (e.g., the electrical damping device and/or the electrical short-circuit device and/or the mechanical damping device (also called mechanical resistance device)) may be used to influence a coupling resistance between the road wheel actuator and the steerable road wheel as a whole.

The variation of the coupling resistance based on the electrical damping device and/or the electrical short-circuit device and/or the mechanical damping device decouples the normal driving configuration based on an SbW system (fault-free) from a configuration in which a TLC is applied and, thus, allows optimization of the coupling resistance for these two different operating states (e.g., fault-free vs. TLC-activated state). Prior approaches do not provide for such a differentiation.

The electrical damping device and the electrical short-circuit device can both be configured to vary a resistance of a component of the coupling path between the road wheel actuator and the steerable road wheel. The varying resistance can propagate into a varying coupling resistance.

The electrical damping device and/or the electrical short-circuit device are preferably coupled to windings of the electric motor of the road wheel actuator. As a result of the activation of the short circuit device, the windings can then be short-circuited. As a result of the short circuit, a current induced in the windings gives rise to a resistance, which is reflected in an increase in the coupling resistance. The electrical damping device may also be coupled to the windings of the electric motor and can be additionally configured when activated to form a variable electrical short-circuit resistance or a variably controllable electrical circuit. For example, the electrical damping device can receive an actuating signal from the control device for this purpose. The actuating signal can be used to indicate how the electrical short-circuit resistance or the controllable electrical circuit is to be varied.

The mechanical damping device can also be configured as a mechanical resistance device. The mechanical damping or resistance device may be designed to vary a mechanical resistance of the coupling path by, for example, causing additional mechanical friction, a positive-locking fit, or a force fit.

In some examples the mechanical damping or resistance device may also be arranged inside or directly on the road wheel actuator and, thus, interact with the road wheel actuator. For example, the mechanical damping or resistance device can interact with a motor shaft, be arranged on a recirculating ball gear, or mechanically act on a belt drive.

The actuator control device is part of the electronic steering system. However, this is not the steering control device (e.g., a steering wheel feedback actuator ECU) of the electronic steering system. The steering control device determines actuating signals and transmits them to the road wheel actuator and the steering wheel actuator. The actuating signals are determined based on a steering input by the driver of the vehicle, the wheel angles of the steerable road wheels and other parameters of the vehicle (e.g., the speed). For example, the electronic steering system may have sensors to detect the road wheel angles. In addition, the steering control device of the electronic steering system can be coupled to a higher-level driving control device (e.g., an external ECU separate from the electronic steering system) of the vehicle, from which it obtains vehicle parameters (e.g., the speed). For example, the steering inputs can be applied using a steering wheel of the vehicle.

In contrast, the actuator control device of the road wheel actuator receives a corresponding actuating signal from the steering control device. As a result, the actuator control device outputs a corresponding actuating signal to the road wheel actuator (e.g., to an electric motor of the road wheel actuator or to an inverter coupled to the road wheel actuator) to steer the steerable road wheel according to the input of the steering control device using a movement of the road wheel actuator.

In some examples, the coupling resistance is varied depending on a steering input for the road wheel actuator. This means that the coupling resistance is not only varied once, but can be varied in different ways depending on different steering inputs. This allows the coupling resistance to be adapted to the current driving situation. This means that the coupling resistance is optimized individually depending on the steering input. For example, the coupling resistance for a cornering maneuver in a stationary state (e.g., for a constant steering input) can be adjusted differently than is the case for varying steering inputs. This allows the coupling resistance to be varied based on the situation.

In some examples, methods disclosed herein may also include detecting a fault (e.g., an unexpected operating state) in the electronic steering system of the vehicle. In this case, the coupling resistance is varied only if a fault in the electronic steering system has been previously detected. In other words, the electronic steering system can operate in the normal state (e.g., operating as intended) with a constant, low coupling resistance. This substantially ensures that mechanical friction losses and increased electrical power losses resulting from them in the conventional operating mode of the electronic steering system can be substantially reduced or eliminated. If, however, a fault then occurs in the electronic steering system of the vehicle, the vehicle lateral control can be maintained based on an auxiliary steering system. The auxiliary steering makes use of the electric motors or deceleration devices that serve to drive the vehicle. The auxiliary steering is therefore equivalent to a tertiary lateral control (TLC) system. A varying coupling resistance is advantageous in such scenarios because an increase in the precision of the lateral control of the vehicle depending on the respective driving situation can be achieved when using the TLC.

In particular, in the normal operating state of the electronic steering system, the coupling resistance can be selected in such a way that it is minimal. This substantially minimizes the power losses caused by the coupling resistance.

A fault in the electronic steering system can be caused, for example, by a steering system component (e.g., a steering actuator or actuator control device) and is detected or discovered, for example, by a sensor of the electronic steering system. A fault does not necessarily refer here to complete inoperability. The fault in the electronic steering system may also be such that the electronic steering system displays a degraded form of operation. For example, due to a fault (e.g., in the steering control device), the electronic steering system may no longer be able to adequately translate steering inputs made by the driver on the steering wheel into changed wheel orientations. In addition, faults can also occur in which functions performed by steering system components of the electronic steering system are outside a defined standard range. For example, sensors may be used as steering system components to transmit measured values to the control device within a defined interval. However, if a measured value is transmitted outside the interval, a fault in the sensor (e.g., a steering system component) can be assumed. This means that it is also possible to detect steering system components that may still be operable, albeit incorrectly, and which may ultimately cause a fault in the electronic steering system.

For example, in some situations the electronic steering system can no longer be used reliably in the conventional operating mode to adequately ensure vehicle lateral control. This differs from inadequate vehicle lateral control due to external conditions such as in the event of high wheel slip due to icy road surfaces. In this sense, the vehicle may include a control device that detects a fault in the electronic steering system and, as a result of the fault detection or the determination that a fault is present, instructs the control device of the auxiliary steering system to continue the method as described herein (e.g., triggering of the auxiliary steering). For example, a higher-level driving control device of the vehicle can operate as the control device of the auxiliary steering.

Alternatively, the inoperability of the electronic steering system can also be detected by a higher-level vehicle control device that performs test functions relating to the functionality of the electronic steering system. In some examples, the driving control device can also act as a control device of the auxiliary steering, as will be explained in detail later.

In some examples, a fault in the electronic steering system is present at least when the actuator control device is de-energized. In such cases, the actuator control device can no longer control the road wheel actuator as required to cause the steering of the steerable road wheels. The variation of the coupling resistance is particularly advantageous in such cases because the coupling resistance can then be matched (e.g., according to the steering input). In such cases, the electronic steering system can also no longer be used according to its conventional functionality. The vehicle lateral control is then affected by an auxiliary steering system.

Therefore, the control device which varies the coupling resistance based on the electrical damping device, the electrical short-circuit device and/or the mechanical damping device, is also not the actuator control device associated with the road wheel actuator. Rather, it is an external control device such as, for example, a higher-level driving control device used for driving the vehicle. In this respect, the driving control device performs a monitoring function with regard to the control device of the electronic steering system and, thus, also with regard to the actuator control device associated with the road wheel actuator.

The driving control device may comprise, for example, a switching device which is configured in such a way that the activity of the electrical damping device, the electrical short-circuit device and/or the mechanical damping device is disabled if the actuator control device is energized. If, on the other hand, the actuator control device is de-energized, the switching device can be closed to enable activity of the aforementioned components. For example, the switching device may comprise an NPN transistor (power-off closed) for this purpose.

In some examples, the switching device can be arranged within the actuator control device or within the road wheel actuator.

The vehicle comprises a plurality of road wheels and a plurality of electric motors and/or deceleration devices (e.g., wheel brakes). The electric motors and/or the deceleration devices are each assigned to a road wheel and are configured to apply a specific torque to the road wheel. The auxiliary steering comprises an auxiliary steering control device and at least one sensor. The sensor may be part of the conventional electronic steering system or may be designed as an auxiliary sensor. The sensor is assigned to a road wheel and is configured to detect an angular position (e.g., a wheel angle) of the road wheel or a corresponding measurement variable and to transmit it to the auxiliary steering control device. The auxiliary steering control device is configured to trigger the auxiliary steering in the event of a fault in the vehicle electronic steering system and to implement steering inputs based on a torque control system. The torque control system is configured in such a way that actuating signals to the electric motors (e.g., phase voltages) and/or deceleration devices can be output so that the electric motors and/or deceleration devices output torques to the respectively assigned road wheels.

Therefore, the auxiliary steering refers to a system that indirectly enables vehicle lateral control, namely by means of different torques output to the respective road wheels. This results in different speeds of the road wheels, which indirectly enables the vehicle to rotate about the vertical axis of the vehicle (e.g., lateral control).

The auxiliary steering control device may preferably be formed by a higher-level driving control device of the vehicle.

Thus, the torque control, which is performed by the auxiliary steering system to provide vehicle lateral control, can advantageously be carried out independently of the conventional electronic steering system of the vehicle. The information about the wheel angle of the at least one road wheel can be acquired by the sensor independently of the conventional electronic steering system, provided that the sensor is an auxiliary sensor separate from the electronic steering system. This helps to substantially reduce or eliminate the need for estimation procedures in the auxiliary steering (e.g., TLC) to estimate the wheel angle information. As a result, the precision of the lateral control of the vehicle using the torque control system can be particularly high, for example, because the immediate detection of the wheel angle using the (auxiliary) sensor allows shorter control intervals than would be the case if an estimation method were applied. Furthermore, the information about the wheel angle of the road wheel, which is acquired by the sensor, can also be robust in the sense that it is not corrupted or generally influenced by faults in the conventional electronic steering system.

This enables vehicle lateral control with high precision and low complexity, since complex estimation methods, for example, are unnecessary.

In some examples, the auxiliary steering can be considered part of the electronic steering system or as separate from it. However, the electronic steering system in its conventional mode of operation does not perform auxiliary steering, which is made possible by the torque control for the electric motors and/or the deceleration devices which are assigned to respective road wheels. As such, the electronic steering system in its conventional mode of operation does not implement the TLC. In contrast to the auxiliary steering system, the conventional electronic steering system in its normal function allows direct vehicle lateral control using the road wheel actuator.

The torque control that is performed by the auxiliary steering control device of the auxiliary steering may be a torque control with feedback. This means that the steering input of the driver of the vehicle is taken into account and, based on the steering input and taking into account the instantaneous wheel angle of the at least one road wheel, actuation inputs are determined which correspond to a target input for the wheel angle. Since multiple road wheels are each assigned an electric motor and/or a deceleration device, a change in the wheel angle can be caused by relative differences in the torque values output to the respective road wheels. In examples disclosed herein, the relative difference between the torques output to the different road wheels in total causes a change in the wheel angle of the at least one road wheel to which the at least one auxiliary sensor is assigned. Typically, at least multiple actuation inputs related to different road wheels are, therefore, used to provide vehicle lateral control to cause a change in the wheel angle of the detected road wheel.

The (auxiliary) sensor in this case does not mean a sensor of the conventional electronic steering system. It means a sensor outside of and separate from the electronic steering system, and which is independent of it. Of course, the auxiliary sensor can be coupled to components of the electronic steering system (e.g., mechanically coupled) depending on the positioning of the auxiliary sensor. Nevertheless, the auxiliary sensor is of such a type that it does not correspond to the sensor of the electronic steering system which conventionally detects the wheel angle of a road wheel and transmits it to a control device of the electronic steering system. The auxiliary sensor is separate from the electronic steering system in such a way that its functionality does not depend on actuating signals or control signals transmitted by a control device of the electronic steering system. The auxiliary sensor is also not coupled to a control device of the conventional electronic steering system. This, therefore, substantially prevents or reduces the likelihood that the auxiliary sensor may be corrupted by a fault in the electronic steering system if such a fault is present.

Advantageously, the vehicle is configured in such a way that a power supply for the auxiliary sensor is provided separately from the electronic steering system. For example, the auxiliary sensor is able to be coupled to an electrical supply circuit that does not depend on the functionality of the electronic steering system.

A deceleration device (e.g., a wheel brake) in the present case refers to a device which is assigned to a road wheel, and which is designed to reduce the rotation speed of the road wheel by, for example, a frictional connection to a friction disc.

In some examples, the auxiliary sensor can be designed to be coupled to a driving control device of the vehicle. The driving control device controls the electric motors and/or deceleration devices used to drive the vehicle. In such examples, the driving control device of the vehicle performs the functionality of the auxiliary steering control device of the auxiliary steering system. For example, the driving control device may in general be a control device that converts speed inputs of the driver of the vehicle into torque inputs, which are output by signal interfaces (e.g., transmitters) to corresponding electric motors and/or deceleration devices for the purpose of driving the vehicle. In this case, a separate auxiliary steering control device of the auxiliary steering system can be omitted, since its functionality is implemented in the driving control device. For this reason, the auxiliary steering system and the vehicle are particularly compact. Since the driving control device can also be designed to monitor the electronic steering system with regard to its functionality and the occurrence of faults, the vehicle may, thus, be particularly compact for the purposes of the auxiliary steering, and the method, for example, may not require any additional circuits except for the auxiliary sensor.

In some examples, the electrical damping device and/or the electrical short-circuit device and/or the mechanical damping device is switchable. This means that it can be activated and deactivated, for example by a control device.

In some examples, the electrical damping device and/or the electrical short-circuit device is activated by the control device or a higher-level driving control device of the vehicle if the road wheel actuator is switched off or de-energized. This can also correspond to a fault in which the electronic steering system is no longer usable according to a normal function. In this case, the auxiliary steering can then be used for lateral control of the vehicle, wherein the precision of the TLC can be increased if the coupling resistance is variable.

In some examples, the electrical damping device and/or the electrical short-circuit device is coupled to a supply circuit or to an energy storage unit.

In some examples, the electrical damping device and/or the electrical short-circuit device can be activated as soon as the road wheel actuator is switched off or de-energized. Then, the control system for activating the electrical damping device and/or short-circuit device is substantially compact.

In some examples, the supply circuit to the electronic steering system is external. In such examples, even in the event of a fault in the electronic steering system, the supply circuit can substantially ensure that the electrical damping device and/or the electrical short-circuit device can still be provided with a supply voltage in line with normal function.

The energy storage unit is preferably internal to the electronic steering system. For example, the energy storage unit can be a capacitor.

Both the supply circuit and the energy storage unit ensure that a supply voltage for the corresponding component (e.g., the electrical damping device and/or the electrical short-circuit device) can be maintained. In some examples, the energy storage unit can be charged while the electronic steering system is switched on and active (e.g., fault-free). In a de-energized state, for example of the faulty actuator control device, the energy storage unit keeps the circuit active so that no external power source is required in the de-energized state. In this case, the switching device may also be a switching device that is open when powered off and for which a supply voltage is required to close it.

In this case, a supply voltage for the mechanical damping element may be necessary because the mechanical damping element itself can include an actuator. By means of the actuator, the mechanical damping element can influence, for example, the coupling resistance.

In some examples, the electrical damping device has a controllable electrical damping and/or a controllable electrical resistance and/or a controllable electrical circuit. This allows the damping behavior of the electrical damping device to be adjusted. For example, it can also be varied during operation. This increases the versatility of the method.

In some examples, the control device is configured to adapt a damping behavior of the electrical damping device according to a target coupling resistance between the road wheel actuator and the steerable road wheel coupled to the road wheel actuator. This further enhances the versatility of the electronic steering system. For example, various fault cases of the electronic steering system may cause the damping behavior of the electrical damping device to vary in different ways to optimize the precision in the lateral control of the vehicle. Therefore, adjusting the damping behavior is advantageous to further increase the precision.

In some examples, the damping behavior of the electrical damping device can be varied by adding or modifying electrical components of the electrical damping device. For example, the electrical damping device may have a switching device that uses additional resistors, capacitors and/or coils in the electrical damping device in its operation to control the damping behavior.

In some examples, the mechanical damping device is coupled to a steering rack of the electronic steering system or is arranged to act inside or on the road wheel actuator, and configured to hold the steering rack in a position and/or release and/or inhibit it, and/or to prevent movement of the steering rack when the road wheel actuator is de-energized. For example, the steering rack is at least indirectly coupled to the steerable road wheels. Therefore, coupling the mechanical damping device to the steering rack is particularly advantageous to provide a variable coupling resistance to steer the steerable road wheels.

Due to the ability to adjust the damping behavior and the electrical damping device, less synchronization effort is required to enable a reduced offset between the steerable road wheels and the steering wheel.

For example, the road wheel actuator may be de-energized when parking. This can then prevent movement of the steering rack.

In some examples, the methods described herein are designed as computer-implemented methods. This means that operations of the methods can be supported by one or more data processing devices. For example, the variation of the coupling resistance can be carried out by a data processing device (e.g., the driving control device).

According to a further aspect, the disclosure also relates to a computer program product comprising commands which, when the program is executed by a computer, cause the computer to execute example methods described herein. The advantages achieved by the methods described herein are also achieved by the computer program product in a corresponding manner.

According to an additional aspect, the disclosure also relates to a computer-readable storage medium comprising commands which, when the program is executed by a computer, cause the computer to execute example methods described herein. The advantages achieved by the methods described herein are also achieved by the computer-readable storage medium in a corresponding manner.

According to an additional aspect, some examples of the disclosure also relate to a vehicle having an electronic steering system. The advantages achieved by the methods described herein are also achieved by the vehicle in a corresponding manner.

For the purposes of the disclosure, vehicles may include, for example, land vehicles, including, but not limited to, off-road and road vehicles such as passenger cars, buses, trucks and other utility vehicles. Vehicles may be manned or unmanned. Vehicles may be at least partially electrically powered, have an internal combustion engine and/or an electric motor serving as the drive.

All the features explained with regard to the various aspects can be combined individually or in (sub) combination with other aspects.

The disclosure as well as other advantageous examples and refinements thereof are described and explained in more detail below with reference to the examples shown in the drawings.

The following detailed description in conjunction with the accompanying drawings, in which identical numbers refer to identical elements, is intended to describe different examples of the disclosed subject matter and is not intended to represent the only examples. Each example described in this disclosure is intended for illustration purposes only and should not be interpreted as preferred or advantageous over other examples. The illustrative examples contained herein do not claim to be complete and do not limit the claimed subject-matter to the exact disclosed forms. Different variations of the described examples and the general principles defined herein may be applied to other examples and applications without departing from the spirit and scope of the described examples. Therefore, the described examples are not limited to the examples shown, but have the widest possible scope compatible with the principles and features disclosed herein.

All the features disclosed below with respect to the described examples and/or the accompanying figures may be combined alone or in any subcombination with features of the aspects of the disclosure.

For the purposes of the disclosure, the wording “at least one of A, B and C” means, for example, (A), (B), (C), (A and B), (A and C), (B and C) or (A, B and C), including any other possible combinations if more than three items are listed. In other words, the term “at least one of A and B” in general means “A and/or B”, namely “A” alone, “B” alone or “A and B”.

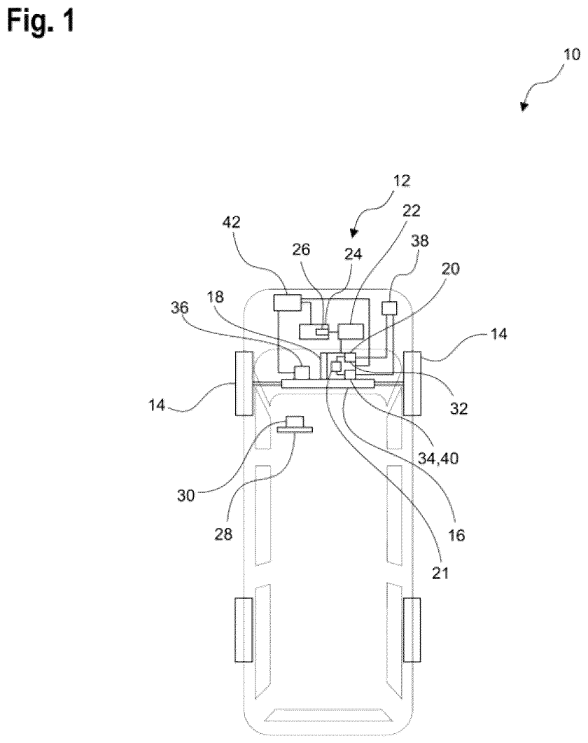

FIG. 1 shows a vehicle 10 having an electronic steering system 12 in accordance with examples disclosed herein.

The vehicle 10 also comprises steerable road wheels 14. The steerable road wheels 14 are coupled to each other by way of a steering rack 16. The steering rack 16 is configured to be moved from a zero position, so that a deflection of the steerable road wheels 14 is effected starting from a straight alignment of the vehicle 10.

To move the steering rack 16, the electronic steering system 12 has a road wheel actuator 18 which is coupled to the steering rack 16. The road wheel actuator 18 comprises an electric motor 20 to move or actuate a mechanical actuator of the road wheel actuator 18. This results in a movement of the steering rack 16, which in turn is reflected in a change in the angular position of the wheel angles of the steerable road wheels 14.

The electronic steering system 12 has an actuator control device 22 (e.g., a road wheel actuator ECU), which is assigned to the road wheel actuator 18 and coupled to the road wheel actuator 18. The electronic steering system 12 also has a steering control device 24 (e.g., a steering wheel feedback actuator ECU), which is coupled to the actuator control device 22. Both the actuator control device 22 and the steering control device 24 can be integrated into the electronic steering system 12.

The decoupling device 24 also has at least one data processing device 26.

The electronic steering system 12 also has a steering wheel 28, which is coupled to a steering wheel actuator 30. The steering wheel actuator 30 is designed such that it can produce a feedback torque on the steering wheel 28 for the driver of the vehicle 10 to convey to the driver a sensation of the lateral control of the vehicle.

The electronic steering system 12 is designed such that steering inputs of the driver of the vehicle 10 can be detected by way of the steering wheel 28. For example, a sensor can be coupled to the steering wheel 28 for this purpose. Based on the steering inputs of the driver of the vehicle 10, the steering control device 24 determines an actuating signal for the actuator control device 22, which in turn controls the road wheel actuator 18 in such a way that the steering input is optimally implemented by deflection of the steerable road wheels 14.

According to the example of FIG. 1, the electric motor 20 of the road wheel actuator 18 has an electrical damping device 32 and an electrical short-circuit device 34. In other examples, both components do not need to be present.

The electrical short-circuit device 34 is configured to produce a short circuit of the windings 21 of the electric motor 20. This generates an electrical resistance that directly affects the coupling resistance between the road wheel actuator 18 and the steerable road wheels 14.

The electrical damping device 32 is configured to effect an electrical resistance within the electric motor 20, for example, by allowing an adjustable short circuit within the windings 21 of the electric motor 20. Unlike the short-circuit device 34, the damping device 32 is configured in such a way that its damping behavior can be adjusted. For example, the damping device 32 may have additional electrical components, such as resistors, coils and/or capacitors, which can be taken into account during the damping as required or can be disregarded. For example, the damping device 32 may have corresponding switching devices for this purpose.

The short-circuit device 34 may also be implemented within the damping device 32 by, for example, dispensing with a variable damping behavior and only short-circuiting the windings 21 of the electric motor 20.

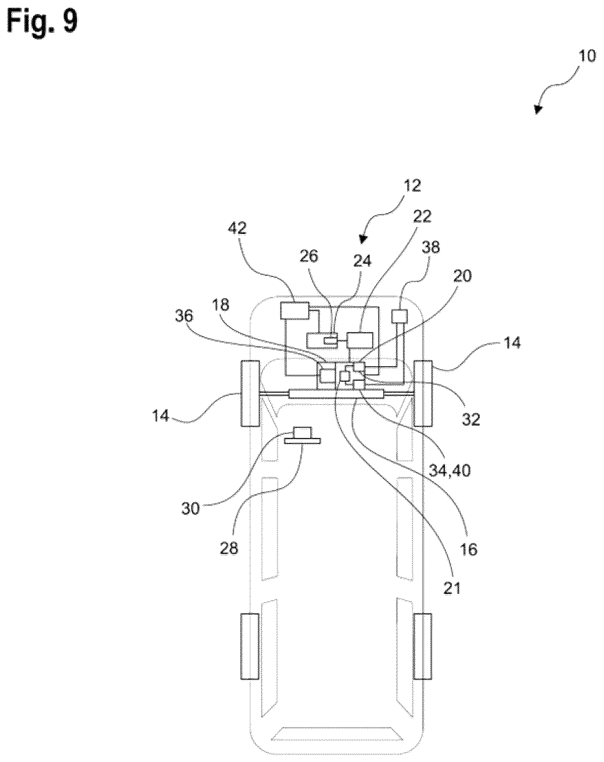

In addition, a mechanical damping device 36 is coupled to the steering rack 16. In some examples, the mechanical damping device 36 can also act on a shaft of an electric motor 20 of the road wheel actuator 18 so that a mechanical coupling can be affected (see FIG. 9). In such examples, the mechanical damping device 36 is arranged within the road wheel actuator 18. Otherwise, the example of FIG. 9 is similar to the example of FIG. 1.

The mechanical damping device 36 is configured to inhibit, stop and/or enable the movement of the steering rack 16. For example, the mechanical damping device 36 can have an element, for example, which causes a frictional or positive fit. Thus, the mechanical damping device 36 is configured to influence a coupling resistance between the road wheel actuator 18 and the steerable road wheels 14.

In the example of FIG. 1, the electrical damping device 32 is coupled to a supply circuit 38 external to the electronic steering system 12 to supply power. This can ensure that a power supply for the electrical damping device 32 can still be maintained, even if the electronic steering system 12 has a fault.

The electrical short-circuit device 34 is also coupled to the external supply circuit 38. In addition, the electrical short-circuit device 34 according to the example of FIG. 1 also has another energy storage unit 40 which is internal to the road wheel actuator 18. Thus, even in the event of a fault in the external supply circuit 38, a power supply for the electrical short-circuit device 34 can still be ensured.

In general, the energy storage unit 40 is optional and can be omitted in other examples.

Although not illustrated in FIG. 1, both the electrical damping device 32 and the mechanical damping device 36 can be coupled to both the external supply circuit 38 which supplies power, or to the internal energy storage unit 40.

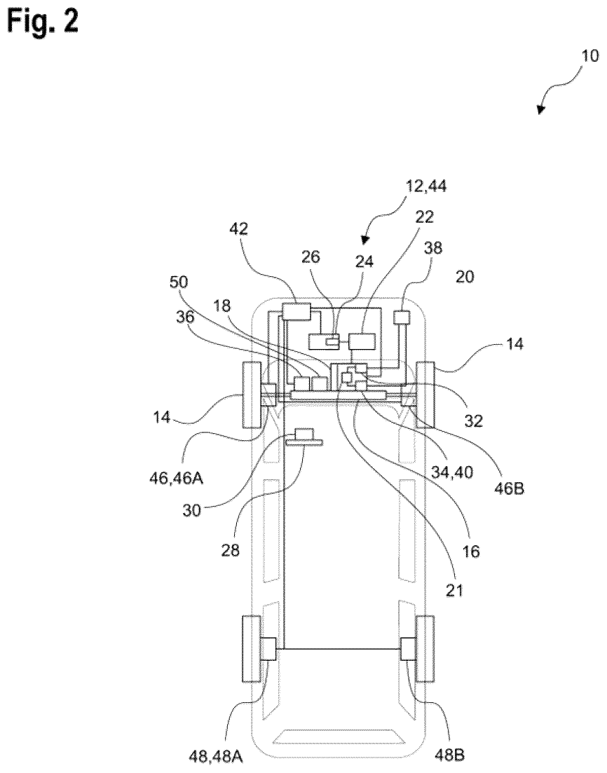

The vehicle 10 additionally comprises a higher-level driving control device 42 (e.g., an external ECU separate from the electronic steering system 12). The higher-level driving control device 42 is configured to control a drive of the vehicle 10. The higher-level driving control device 42 may be designed to exert a torque control for the purpose of driving and/or slowing down the vehicle 10 by means of electric motors 46 and/or deceleration device 48 (e.g., wheel brakes) (see FIG. 2). This means that the basic driving functions of the propulsion of the vehicle 10 or the deceleration of the vehicle 10 are already performed by the higher-level driving control device 42. Since the higher-level driving control device 42 can also assume the control functions of an auxiliary steering system 44 (see FIG. 2), the auxiliary steering system 44 is then substantially compact and requires no additional components apart from the auxiliary sensor 50. This makes the vehicle 10 substantially compact.

The higher-level driving control device 42 also performs monitoring functions related to the electronic steering system 12. For example, the higher-level driving control device 42 is configured to monitor whether the electronic steering system 12 is operating properly.

The higher-level driving control device 42 is configured to vary the coupling resistance between the road wheel actuator 18 and the steerable road wheels 14 based on at least one of the electrical damping device 32, the electrical short-circuit device 34 and/or the mechanical damping device 36.

In addition, the higher-level driving control device 42 is configured to take into account steering inputs of the driver of the vehicle 10 made using the steering wheel 28 when varying the coupling resistance.

FIG. 2 shows another example of the vehicle 10 with another example of the electronic steering system 12 and an auxiliary steering system 44 (TLC) in accordance with examples disclosed herein. Only the differences relative to the example of FIG. 1 will be discussed here.

If a fault occurs in connection with the electronic steering system 12 (e.g., a fault in the road wheel actuator 18), the auxiliary steering system 44 can be used for the lateral control of the vehicle 10. In general, the vehicle 10 has electric motors 46, 46A, 46B to drive the vehicle 10, each of which is assigned to a corresponding one of the steerable road wheels 14. In addition, the vehicle 10 has deceleration devices 48, 48A, 48B (e.g., wheel brakes), each of which is assigned to a corresponding one of the rear road wheels 14. In other examples, all the road wheels of the vehicle 10 can be assigned respective electric motors 46 and/or deceleration devices 48.

In addition, an auxiliary sensor 50, which is separate from the electronic steering system 12, is provided for the auxiliary steering system 44. This means that the auxiliary sensor 50 is not a sensor that is used by the electronic steering system 12 in the normal operation of the electronic steering system 12. Due to the fact that the auxiliary sensor 50 is separate from the electronic steering system 12, if there is a fault in the electronic steering system 12, the operation of the auxiliary sensor 50 is not affected by the fault.

In the example of FIG. 2, the auxiliary sensor 50 is electrically coupled to the steering rack 16. In the example of FIG. 2, the auxiliary sensor 50 is configured to detect a wheel angle of the steerable road wheels 14 of the vehicle 10 based on the position and/or a movement of the steering rack 16.

According to the example of FIG. 2, the higher-level driving control device 42 is coupled to the electric motors 46, the deceleration devices 48 and the auxiliary sensor 50. In addition, the driving control device 42 in the example of FIG. 2 is configured to detect a fault in the electronic steering system 12. In the event of a fault, the driving control device 42 can then trigger the auxiliary steering system 44 and effect lateral control of the vehicle 10 based on the electric motors 46 and/or the deceleration devices 48. This is made possible by subjecting the respective road wheels 14 of the vehicle 10 to different torques generated by the electric motors 46 and/or the deceleration devices 48. For example, the driving control device 42 controls the electric motors 46 and/or the deceleration devices 48 based on the steering inputs of the driver of the vehicle 10 via the steering wheel 28 to produce different torques for the road wheels 14 of the vehicle 10.

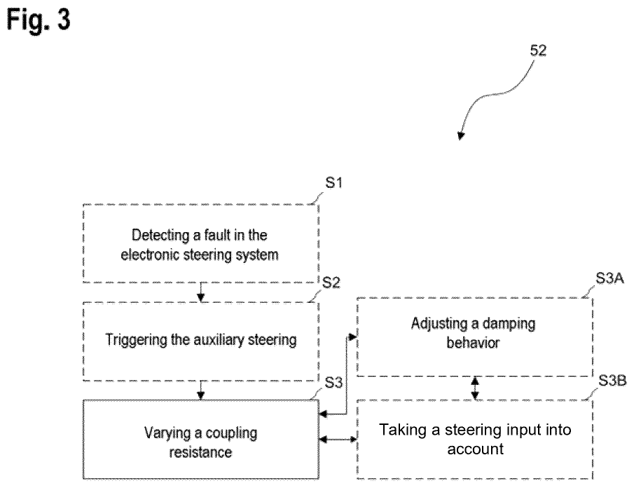

FIG. 3 is a flowchart representative of example machine-readable instructions and/or example operations that may be executed, instantiated, and/or performed by example programmable circuitry to implement a method 52 to operate the vehicle 10 based on the electronic steering system 12. Optional operations are shown by dashed lines.

Referring to the example of FIG. 3, at S1 of the method 52, a fault in the electronic steering system 12 is detected. For example, a sensor of the electronic steering system 12 can detect that the road wheel actuator 18 is no longer operating properly (e.g., a power supply to the road wheel actuator 18 has become unavailable or inoperable). The fault in the electronic steering system 12 can be detected by the higher-level driving control device 42, or at least it can be monitored and detected in due course.

At S2, the auxiliary steering system 44 of the vehicle 10 is then triggered by, for example, the higher-level driving control device 42. This means that the electronic steering system 12 is no longer used for lateral control of the vehicle 10 based on a conventional mode of operation, but instead the electric motors 46 and/or deceleration devices 48 are used to drive the vehicle 10. To enable lateral control of the vehicle 10 based on the electric motors 46 and/or the deceleration devices 48, the higher-level driving control device 42 may have a torque control function, for example.

In S3 of the method 52, the coupling resistance between the road wheel actuator 18 and the steerable road wheel 14 coupled to the road wheel actuator 18 is varied by means of a control device of the vehicle 10.

In the example of FIG. 3, the control device of the vehicle 10 is the superordinate driving control device 42. Alternatively, a separately provided control device of the vehicle 10 can also be used to vary the coupling resistance as described.

In any case, the variation of the coupling resistance is not affected by the control device of the electronic steering system 12, since the variation of the coupling resistance is advantageous for configurations in which the electronic steering system 12 has a fault and lateral control of the vehicle 10 is implemented by the auxiliary steering system 44. Due to the fact that the variation of the coupling resistance is effected by a control device external to the electronic steering system 12, the possibility that the variation of the coupling resistance may be influenced by the fault of the electronic steering system 12 is substantially reduced or eliminated.

The variation of the coupling resistance is based on at least one of the electrical damping device 32, the electrical short-circuit device 34 and/or the mechanical damping device 36. The higher-level driving control device 42 can output a corresponding actuating signal to the respective one of the electrical damping device 32, the electrical short-circuit device 34 and/or the mechanical damping device 36 to control the coupling resistance between the road wheel actuator 18 and the steerable road wheel 14.

Step S3 can be modified in a variety of ways. For example, step S3 can be extended by step S3A, in which a damping behavior during the variation of the coupling resistance by the higher-level driving control device 42 is adjusted. For example, the electrical damping device 32 can be used, which can have a controllable electrical circuit.

Alternatively or additionally, when the coupling resistance is varied by the higher-level driving control device 42 according to step S3B, a steering input of the driver of the vehicle 10, which the driver makes using the steering wheel 28, can be taken into account. As a result, despite the presence of a fault in the electronic steering system 12, lateral control of the vehicle 10 desired by the driver can be implemented (e.g., with increased precision compared to previous approaches). Different coupling resistances are advantageous depending on the steering inputs. For example, for a constant steering specification (e.g., constant cornering), a different coupling resistance is advantageous compared to a variation of the steering input.

Example instructions and/or operations of FIG. 3 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

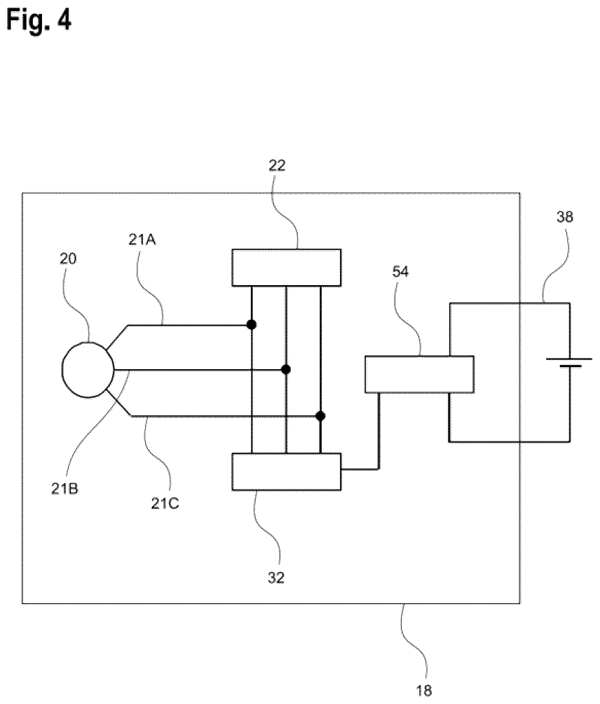

FIGS. 4 to 7 show schematic representations of an example electrical damping device 32 in connection with the electronic steering system 12 according to different example implementations. Only the differences between the different example implementations will be discussed here.

The road wheel actuator 18 comprises the electric motor 20 with the windings 21A, 21B, 21C. The windings 21 are coupled to the actuator control device 22 so that the electric motor 20 can be controlled accordingly to bring about a movement of the steering rack 16 based on the road wheel actuator 18.

According to the examples of FIGS. 4-7, the electrical damping device 32 is also coupled to the windings 21. The electrical damping device 32 is configured to affect the resistance in the windings 21. For this purpose, the electrical damping device 32 can have, for example, electrical components such as resistors, coils and/or capacitors. A switching device 54 is provided to control the activity status of the electrical damping device 32. For this purpose, the switching device 54 according to the example of FIG. 4 is coupled to an external supply circuit 38 that supplies power. In the example of FIG. 4, the switching device 54 is configured as power-off open. This means that the damping device 32 is not activated whenever the circuit device 54 receives a supply voltage from the supply circuit 38. If the power supply of the supply circuit 38 is faulty, the electrical damping device 32 is activated and, thus, affects the electrical resistance in the windings 21 of the electric motor 20 of the road wheel actuator 18. As a result, the coupling resistance between the road wheel actuator 18 and the steerable road wheels 14 of the vehicle 10 is affected.

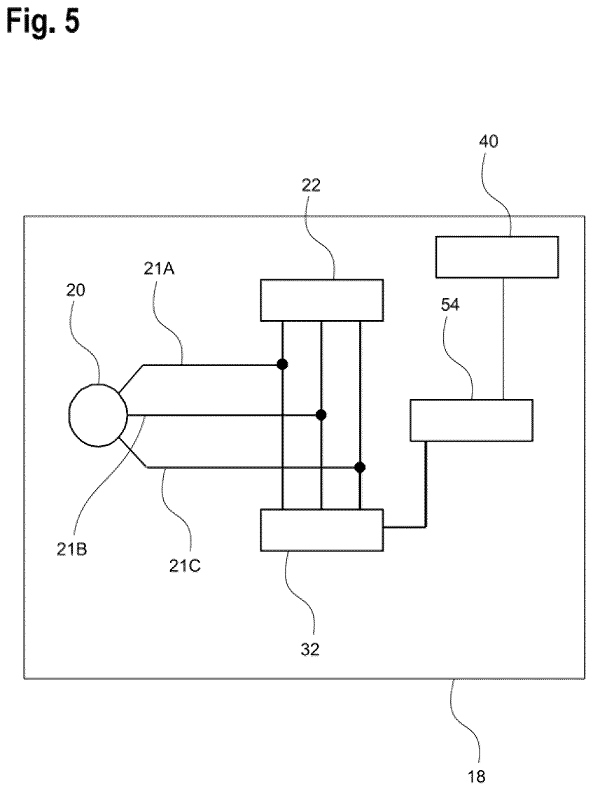

Instead of the coupling to an external supply circuit 38, the switching device 54 can also be coupled to an energy storage unit 40 (e.g., a capacitor) as shown in FIG. 5. In general, the energy storage unit 40 can be internal or external to the road wheel actuator 18.

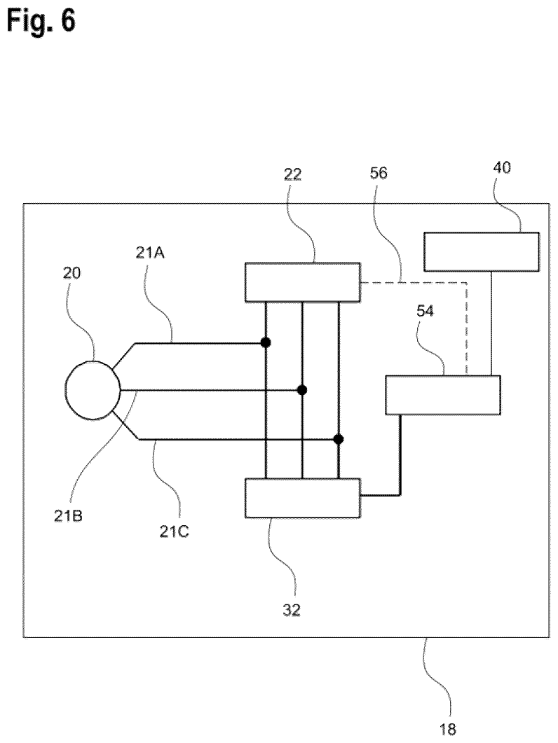

In the example of FIG. 6, the actuator control device 22 can output a blocking signal 56 to the switching device 54, which determines whether the electrical damping device 32 is activated or deactivated. The switching device 54 may include a suitable transistor (e.g., a PNP or an NPN transistor) to activate the electrical damping device 32.

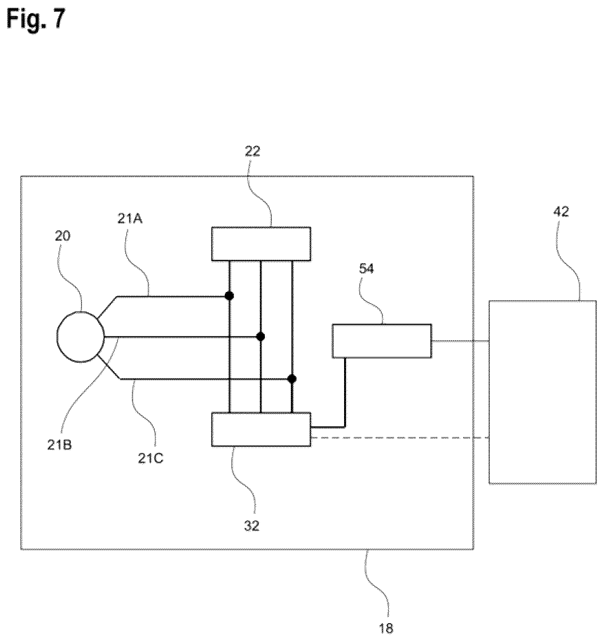

In the example of FIG. 7, the switching device 54 and the electrical damping device 32 may also be coupled to a control device of the vehicle 10 (e.g., the higher-level driving control device 42). The higher-level driving control device 42 can control the state of the switching device 54 and/or influence the damping behavior of the electrical damping device 32 to vary the coupling resistance between the road wheel actuator 18 and the steerable road wheels 14. For this purpose, the electrical damping device 32 may include, for example, an adjustable electrical resistance. Thus, for example, different states of the electronic steering system 12 (e.g., based on different steering specifications by the driver of the vehicle 10) can be taken into account and the damping behavior of the electrical damping device 32 can be matched to the respective steering input.

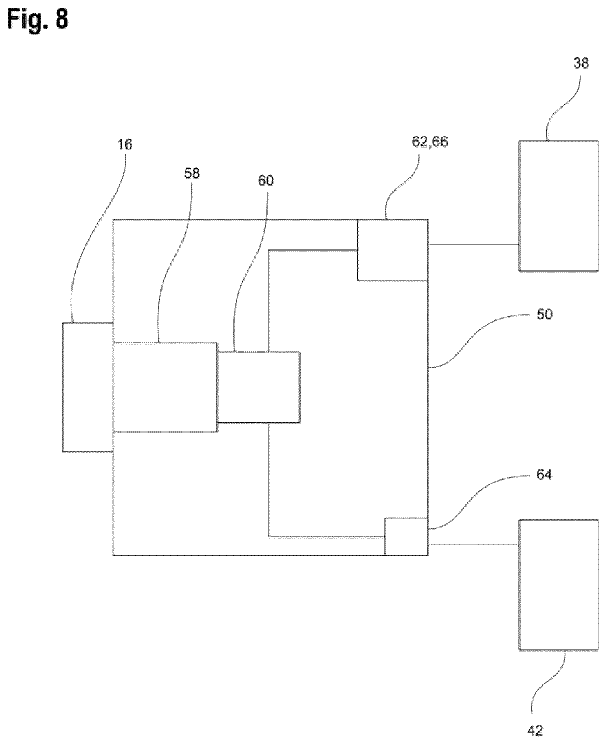

FIG. 8 shows a schematic representation of an auxiliary sensor 50 in connection with the auxiliary steering system 44.

The auxiliary sensor 50 includes a sensor element 58, sensor logic 60, a supply terminal 62 and a communication interface 64. The sensor element 58 enables a measurement acquisition with respect to an external mechanical component (e.g., the steering rack 16) coupled to the auxiliary sensor 50. In such examples, the sensor element 58 is configured to detect a positional change or a movement of the external mechanical component such as a steering rack travel of the steering rack 16 relative to a reference position (zero position). The sensor logic 60 is configured to interpret the measurements acquired via the sensor element 58 and to provide them for other components of the auxiliary steering system 44. The supply terminal 62 is configured to allow coupling to an external circuit to supply power to the auxiliary sensor 50. For example, the auxiliary sensor 50 may be coupled by way of the supply terminal 62 to an external supply circuit 38 for the power supply. The communication interface 64 is configured to enable a combination with external components of the vehicle 10 such as, for example, with the higher-level driving control device 42.

The sensor element 58 can be designed as, for example, a Hall sensor, a magnetic ring, a solenoid coil, a displacement sensor or similar. Alternatively, the sensor element 58 can also be designed as a pinion sensor.

The communication interface 64 is configured to enable bidirectional communication between the auxiliary sensor 50 and an external component such as, for example, the higher-level driving control device 42 of the auxiliary steering system 44.

The supply terminal 62 of the auxiliary sensor 50 can be configured such that it can also be coupled to a plurality of supply circuits 38 of the vehicle 10 for the purpose of supplying power to the auxiliary sensor 50. This can provide redundancy relative to the power supply. For this purpose, the supply terminal 62 may include a circuit breaker 66 that, for example, selectively enables the actual current flow with a specific supply circuit 38. If a specific supply circuit 38 were no longer available, the auxiliary sensor 50 can be coupled to another supply circuit 38, depending on the switching position of the circuit breaker 66. The control of the circuit breaker 66 can be performed by, for example, the sensor logic 60 of the auxiliary sensor 50.

The present method 52 enables a high precision of the electronic steering system 12 due to the variable coupling resistance between the road wheel actuator 18 and the steerable road wheels 14 when, for example, lateral control of the vehicle 10 is provided by the auxiliary steering system 44 (TLC). As a result, the coupling resistance can be adjusted based on the steering inputs of the driver of the vehicle 10. In this way, the electronic steering system 12 can be adapted according to different situations, unlike in previous approaches. This increases the precision of lateral control of the vehicle 10, although the electronic steering system 12 is compact. In addition, examples disclosed herein substantially reduce or eliminate the likelihood that a fault in the electronic steering system 12 can affect the possibility of varying the coupling resistance.

Examples disclosed herein may use circuits (e.g. one or more circuits) to implement standards, protocols, methods or technologies disclosed herein, to couple two or more components in a functional manner, to generate information, to process information, to analyze information, to generate signals, to encode/decode signals, to convert signals, to transmit and/or receive signals, to control other devices, etc. Any type of circuit can be used.

In some examples, a circuit such as the control device comprises at least one or more data processing devices such as a processor (e.g. a microprocessor), a central processor unit (CPU), a digital signal processor (DSP), an application-specific integrated circuit (ASIC), a field programmable gate array (FPGA), a system on a chip (SoC) or similar, or any combination thereof, and may comprise discrete digital or analog circuitry or electronics or combinations thereof. In some examples, the circuit comprises hardware circuit implementations (e.g. implementations in analog circuits, implementations in digital circuits and the like, and combinations thereof).

In some examples, circuits comprise combinations of circuits and computer program products with software or firmware instructions, which are stored on one or more computer-readable memories and interact to cause a device to perform one or more of the protocols, methods or technologies described herein. In some examples, the circuit technology comprises circuits, such as microprocessors or parts of microprocessors, that require software, firmware and the like for their operation. In some examples, the circuits comprise one or more processors or parts thereof and the associated software, firmware, hardware and the like.

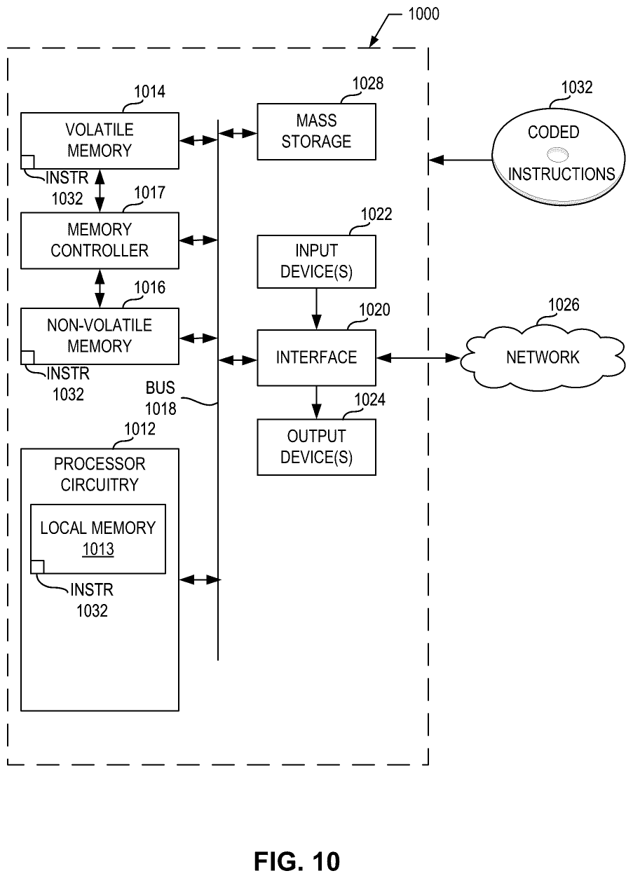

FIG. 10 is a block diagram of an example programmable circuitry platform 1000 structured to execute and/or instantiate the example machine-readable instructions and/or the example operations of FIG. 3 to implement the electronic steering system 12 and/or its various components disclosed herein. The programmable circuitry platform 1000 can be, for example, a control device, an ECU, a self-learning machine (e.g., a neural network), or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAS, microprocessors, CPUs, GPUs, VPUs, DSPs, and/or microcontrollers from any desired family or manufacturer. The programmable circuitry 1012 may be implemented by one or more semiconductor based (e.g., silicon based) devices.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a button, a touchscreen, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1032, which may be implemented by the machine-readable instructions of FIG. 3, may be stored in the mass storage device 1028, in the volatile memory 1014, in the non-volatile memory 1016, and/or on at least one non-transitory computer readable storage medium such as a CD or DVD which may be removable.

Example methods, apparatus, systems, and articles of manufacture to implement electronic steering systems and apparatus for vehicles and methods thereof are disclosed herein. Further examples and combinations thereof include the following:

Example 1 includes a method comprising setting a coupling resistance between a road wheel actuator and a steerable road wheel of a vehicle at a first time by controlling an electrical damping device to increase an electrical resistance of an electric motor of the road wheel actuator, and changing the coupling resistance between the road wheel actuator and the steerable road wheel at a second time by controlling the electrical damping device to further increase the electrical resistance of the electric motor of the road wheel actuator.

Example 2 includes any preceding clause(s) of example 1, wherein the setting of the coupling resistance at the first time is based on a first steering input for the road wheel actuator and the changing of the coupling resistance at the second time is based on a second steering input for the road wheel actuator.

Example 3 includes any preceding clause(s) of one or both of example 1 and/or example 2, including detecting a fault in an electronic steering system of the vehicle, wherein the changing of the coupling resistance is based on the fault occurring in the electronic steering system.

Example 4 includes any preceding clause(s) of one or more of examples 1-3, wherein the fault in the electronic steering system is present when an actuator control device is de-energized, the actuator control device coupled to the road wheel actuator.

Example 5 includes any preceding clause(s) of one or more of examples 1-4, including activating the electrical damping device in response to the road wheel actuator being switched off or de-energized.

Example 6 includes any preceding clause(s) of one or more of examples 1-5, wherein the electrical damping device is in a first electronic control unit corresponding to the road wheel actuator, the controlling of the electrical damping device based on a second electronic control unit separate from the first electronic control unit.

Example 7 includes any preceding clause(s) of one or more of examples 1-6, including energizing the electrical damping device based on at least one of a supply circuit or an energy storage unit.

Example 8 includes any preceding clause(s) of one or more of examples 1-7, wherein the controlling of the electrical damping device includes changing the electrical resistance of the electric motor to one of a plurality of electrical resistances.

Example 9 includes any preceding clause(s) of one or more of examples 1-8, including configuring a control device to adapt a damping behavior of the electrical damping device based on a target coupling resistance between the road wheel actuator and the steerable road wheel.

Example 10 includes any preceding clause(s) of one or more of examples 1-9, including operating a mechanical damping device coupled to a steering rack of an electronic steering system to at least one of hold the steering rack in a position, release the steering rack, or prevent movement of the steering rack when the road wheel actuator is de-energized.

Example 11 includes an electronic steering system of a vehicle, the system comprising a road wheel actuator including an electric motor, an electrical short-circuit device coupled to the electric motor, the electrical short-circuit device to short circuit windings of the electric motor to generate a first electrical resistance of the electric motor that changes a coupling resistance between the road wheel actuator and a steerable road wheel, and an electrical damping device coupled to the electric motor, the electrical damping device controllable to generate a plurality of second electrical resistances, the second electrical resistances different from the first electrical resistance, the second electrical resistances to vary the coupling resistance between the road wheel actuator and the steerable road wheel.

Example 12 includes any preceding clause(s) of example 11, further including a mechanical damping device in a coupling path between the road wheel actuator and the steerable road wheel, the mechanical damping device configurable to vary the coupling resistance between the road wheel actuator and the steerable road wheel.

Example 13 includes any preceding clause(s) of one or both of example 11 and/or example 12, wherein the mechanical damping device is configurable to at least one of hold a steering rack in a position, release the steering rack, or prevent movement of the steering rack when the road wheel actuator is de-energized.

Example 14 includes any preceding clause(s) of one or more of examples 11-13, wherein the electrical damping device is controllable to generate the plurality of second electrical resistances based on steering inputs for the road wheel actuator.

Example 15 includes any preceding clause(s) of one or more of examples 11-14, including a control device to activate the electrical damping device based on a fault in the electronic steering system.

Example 16 includes a steering system of a vehicle, the steering system comprising a road wheel actuator including an electric motor, an electrical damping device coupled to the electric motor, the electrical damping device controllable to generate a plurality of electrical resistances in the electric motor, the electrical resistances to vary a coupling resistance between the road wheel actuator and a steerable road wheel, and a mechanical damping device in a coupling path between the road wheel actuator and the steerable road wheel, the mechanical damping device configurable to vary the coupling resistance between the road wheel actuator and the steerable road wheel.

Example 17 includes any preceding clause(s) of example 16, wherein the mechanical damping device is configurable to at least one of hold a steering rack in a position, release the steering rack, or prevent movement of the steering rack when the road wheel actuator is de-energized.

Example 18 includes any preceding clause(s) of one or both of example 16 and/or example 17, wherein the electrical damping device is controllable to generate the plurality of electrical resistances based on steering inputs for the road wheel actuator.

Example 19 includes any preceding clause(s) of one or more of examples 16-18, wherein the electrical damping device is coupled to windings of the electric motor and to a control device, the electrical damping device to receive an actuating signal from the control device, the actuating signal indicative of how much to vary an electrical short-circuit resistance in the windings, the electrical short-circuit resistance to vary the coupling resistance between the road wheel actuator and the steerable road wheel.

Example 20 includes any preceding clause(s) of one or more of examples 16-19, including an electrical short-circuit device coupled to windings of the electric motor, the electrical short-circuit device to increase the coupling resistance between the road wheel actuator and the steerable road wheel by short-circuiting the windings of the electric motor, the electrical damping device including an adjustable electrical resistance to generate the plurality of electrical resistances in the electric motor.

This disclosure may refer to quantities and figures. Unless expressly stated, such quantities and numbers shall not be considered as limiting, but as examples of the possible quantities or numbers in connection with the disclosure. In this context, the term “plurality” may also be used in the disclosure to refer to a quantity or number. In this context, the term “plurality” shall mean any number greater than one, for example, two, three, four, five, etc. The terms “roughly”, “approximately”, “near”, etc. mean plus or minus 5% of the value specified.

Although the disclosure has been presented and described with respect to one or more examples, after reading and understanding this description and the accompanying drawings, a person skilled in the art will be able to make equivalent changes and modifications.

What is claimed is:

1. A method comprising:
setting a coupling resistance between a road wheel actuator and a steerable road wheel of a vehicle at a first time by controlling an electrical damping device to increase an electrical resistance of an electric motor of the road wheel actuator; and
changing the coupling resistance between the road wheel actuator and the steerable road wheel at a second time by controlling the electrical damping device to further increase the electrical resistance of the electric motor of the road wheel actuator.

2. The method of claim 1, wherein the setting of the coupling resistance at the first time is based on a first steering input for the road wheel actuator and the changing of the coupling resistance at the second time is based on a second steering input for the road wheel actuator.

3. The method of claim 1, including detecting a fault in an electronic steering system of the vehicle, wherein the changing of the coupling resistance is based on the fault occurring in the electronic steering system.

4. The method of claim 3, wherein the fault in the electronic steering system is present when an actuator control device is de-energized, the actuator control device coupled to the road wheel actuator.

5. The method of claim 1, including activating the electrical damping device in response to the road wheel actuator being switched off or de-energized.

6. The method of claim 1, wherein the electrical damping device is in a first electronic control unit corresponding to the road wheel actuator, the controlling of the electrical damping device based on a second electronic control unit separate from the first electronic control unit.

7. The method of claim 1, including energizing the electrical damping device based on at least one of a supply circuit or an energy storage unit.

8. The method of claim 1, wherein the controlling of the electrical damping device includes changing the electrical resistance of the electric motor to one of a plurality of electrical resistances.

9. The method of claim 1, including configuring a control device to adapt a damping behavior of the electrical damping device based on a target coupling resistance between the road wheel actuator and the steerable road wheel.

10. The method of claim 1, including operating a mechanical damping device coupled to a steering rack of an electronic steering system to at least one of: hold the steering rack in a position, release the steering rack, or prevent movement of the steering rack when the road wheel actuator is de-energized.

11. An electronic steering system of a vehicle, the system comprising:
a road wheel actuator including an electric motor;
an electrical short-circuit device coupled to the electric motor, the electrical short-circuit device to short circuit windings of the electric motor to generate a first electrical resistance of the electric motor that changes a coupling resistance between the road wheel actuator and a steerable road wheel; and
an electrical damping device coupled to the electric motor, the electrical damping device controllable to generate a plurality of second electrical resistances, the second electrical resistances different from the first electrical resistance, the second electrical resistances to vary the coupling resistance between the road wheel actuator and the steerable road wheel.

12. The electronic steering system of claim 11, further including a mechanical damping device in a coupling path between the road wheel actuator and the steerable road wheel, the mechanical damping device configurable to vary the coupling resistance between the road wheel actuator and the steerable road wheel.

13. The electronic steering system of claim 12, wherein the mechanical damping device is configurable to at least one of: hold a steering rack in a position, release the steering rack, or prevent movement of the steering rack when the road wheel actuator is de-energized.

14. The electronic steering system of claim 11, wherein the electrical damping device is controllable to generate the plurality of second electrical resistances based on steering inputs for the road wheel actuator.

15. The electronic steering system of claim 11, including a control device to activate the electrical damping device based on a fault in the electronic steering system.

16. A steering system of a vehicle, the steering system comprising:
a road wheel actuator including an electric motor;
an electrical damping device coupled to the electric motor, the electrical damping device controllable to generate a plurality of electrical resistances in the electric motor, the electrical resistances to vary a coupling resistance between the road wheel actuator and a steerable road wheel; and
a mechanical damping device in a coupling path between the road wheel actuator and the steerable road wheel, the mechanical damping device configurable to vary the coupling resistance between the road wheel actuator and the steerable road wheel.

17. The steering system of claim 16, wherein the mechanical damping device is configurable to at least one of: hold a steering rack in a position, release the steering rack, or prevent movement of the steering rack when the road wheel actuator is de-energized.

18. The steering system of claim 16, wherein the electrical damping device is controllable to generate the plurality of electrical resistances based on steering inputs for the road wheel actuator.

19. The steering system of claim 16, wherein the electrical damping device is coupled to windings of the electric motor and to a control device, the electrical damping device to receive an actuating signal from the control device, the actuating signal indicative of how much to vary an electrical short-circuit resistance in the windings, the electrical short-circuit resistance to vary the coupling resistance between the road wheel actuator and the steerable road wheel.

20. The steering system of claim 16, including an electrical short-circuit device coupled to windings of the electric motor, the electrical short-circuit device to increase the coupling resistance between the road wheel actuator and the steerable road wheel by short-circuiting the windings of the electric motor, the electrical damping device including an adjustable electrical resistance to generate the plurality of electrical resistances in the electric motor.
